(19) United States
(12) Patent Application Publication
(10) Pub. No.: US 2022/0063053 A1
(43) Pub. Date: Mar. 3, 2022

(54) PROCESSING MACHINE

(71) Applicant: DISCO CORPORATION, Tokyo (JP)

(72) Inventor: Jiro GENOZONO, Tokyo (JP)

(21) Appl. No.: 17/402,779

(22) Filed: Aug. 16, 2021

(30) Foreign Application Priority Data
Aug. 27, 2020 (JP) 2020-143353

(51) Int. Cl. B24B 41/00; B24B 7/22; B24B 41/06; B24B 41/047; B23C 1/06

(52) U.S. Cl. CPC B24B 41/002; B24B 7/228; B23C 1/06; B24B 41/047; B24B 41/06

(57) ABSTRACT

Disclosed herein is a processing machine including a processing unit and a workpiece holding unit. The processing unit has a processor wheel with a processor fixed on a lower surface of an annular base, and a mount fixed on a spindle, and processes a workpiece by the processor with the processor wheel mounted on the mount. The processor wheel has a plurality of flange portions arranged at equal angular intervals on an inner peripheral surface of the annular base and extending from the inner peripheral surface toward a center of the processor wheel. The mount has a plurality of clasp portions configured to clasp the flange portions, a plurality of springs biasing the clasp portions in an upward direction in an axial direction of the spindle, and a plurality of support portions configured to support the clasp portions movably in the axial direction.

### BACKGROUND OF THE INVENTION

### Field of the Invention

The present invention relates to a processing machine for processing a workpiece such as a semiconductor wafer.

### Description of the Related Art

A grinding machine has a mount arranged on a distal end of a spindle, and a grinding wheel mounted on the mount. The grinding wheel includes a plurality of grinding stones arranged in an annular pattern on an annular base. The spindle is rotated so that a workpiece, which is held on a chuck table, is ground by the grinding stones. As the grinding stones wear out after grinding a plurality of workpieces, the grinding wheel is replaced with a new one at an appropriate timing.

The mount includes a mounting surface on which the grinding wheel is to be mounted, and a plurality of through-holes formed in an annular pattern in the mounting surface. On the other hand, the grinding wheel includes a plurality of internally threaded holes formed corresponding to the through-holes in a mounted surface of the annular base to be mounted on the mounting surface. The grinding wheel is mounted on the mount by inserting screws through the through-holes and then bringing the screws into threaded engagement with the internally threaded holes. In addition, there is also a grinding machine described, for example, in JP 2019-202399A, which enables to replace a grinding wheel by a simple sliding of a spring-biased movable claw.

### SUMMARY OF THE INVENTION

When the screw-fixed grinding wheel is replaced, the plurality of screws is removed. When mounting a new grinding wheel, on the other hand, the plurality of screws is brought back into threaded engagement with the internally threaded holes. This replacement work involves a problem that it takes a long time, because the removal and installation of the screws are performed as described above. A processing machine, such as a grinding machine, that processes a workpiece by a processor such as grinding stones therefore involves a problem to be solved so that a processor wheel can be replaced in a short time.

Further, the invention described in JP 2019-202399A mounts the grinding wheel by a plurality of claws, which are fixed on a mount connected to a spindle, and a plurality of spring-biased movable claws arranged on the mount. If the inner peripheral diameter of the grinding wheel varies even within a tolerance, the center of the mount, in other words, the axis of the spindle and the center of the grinding wheel no longer match each other so that the center of the grinding wheel, which is being rotated by rotation of the spindle and is performing grinding, becomes eccentric and vibrations occur on the grinding wheel, thereby raising a problem that greater variations occur in the thickness of a ground workpiece.

In a processing machine, there is accordingly a problem to be solved so that the center of a processor wheel mounted on a mount and the center of the mount match each other and no vibrations are produced when a spindle is rotated. There is also a problem to be solved so that no clearance is formed between the mounting surface of the mount and the mounted surface of the grinding wheel by rotation of the spindle.

In accordance with an aspect of the present invention, there is provided a processing machine including a processing unit that has a processor wheel with a processor fixed on a lower surface of an annular base and a mount fixed on a distal end of a spindle, and processes a workpiece by the processor with the processor wheel mounted on a mounting surface of the mount, and a holding unit that holds the workpiece. The processor wheel has a plurality of flange portions arranged at equal angular intervals on an inner peripheral surface of the annular base and extending from the inner peripheral surface toward a center of the processor wheel. The mount has a plurality of clasp portions configured to clasp the flange portions, respectively, a plurality of springs biasing the clasp portions, respectively, in an upward direction in an axial direction of the spindle, and a plurality of support portions configured to support the respective clasp portions movably in the axial direction. The mount has at least one projected portion or recessed portion formed on or in the mounting surface, and the annular base has at least one recessed portion or projected portion formed in or on an upper surface thereof, and the projected portion or recessed portion formed on or in the mounting surface and the recessed portion or projected portion formed in or on the upper surface of the annular base are in detachable fitting engagement with each other, whereby the processor wheel mounted on the mounting surface is prevented from rotating on the mounting surface.

Preferably, the processing unit may include a fixing system to fix the spindle so that the spindle does not rotate. Preferably, the processor may be a grinding wheel, and the processor wheel may have a plurality of grinding stones arranged in an annular pattern on a lower surface of the annular base.

Preferably, the processor may be a polishing pad, and the processor wheel may have the polishing pad arranged on a lower surface of the annular base. Preferably, the processor may be a single point cutting tool, and the processor wheel may have the single point cutting tool arranged on a lower surface of the annular base.

According to the present invention, it is not required to perform the installation and removal of screws when mounting or dismounting the processor wheel on or from the mount. The processor wheel can therefore be replaced in a short time. Further, during grinding processing, the processor wheel is maintained in close contact with the mounting surface of the mount under a centrifugal force produced by rotation of the spindle. The processor can hence be suppressed from wobbling on the workpiece, thereby enabling to avoid leaving adverse effects on a processed surface of the workpiece after the processing and also to provide the workpiece with enhanced flatness.

Preferably, the processing unit includes the fixing system to fix the spindle so that during a replacement of the processor wheel, for example, the spindle does not rotate. Owing to the fixing system, it is possible to appropriately perform matching work or the like with ease between the mount and a new processor wheel during mounting work of the new processor wheel.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a perspective view depicting a processing machine according to a first embodiment of the present invention;

FIG. 2 is a cross-sectional view depicting a processing unit with a processor wheel mounted on a mount in the processing machine of FIG. 1;

FIG. 3 is a plan view of the processor wheel of FIG. 2 as viewed from a side of an upper surface of an annular base;

FIG. 4 is a bottom view of the mount of FIG. 2 as viewed from a side of a mounting surface on which the annular base is to be mounted;

FIG. 5 is a fragmentary cross-sectional view of a processing machine according to a modification of the first embodiment, and depicts the processor wheel and the mount in which compression coil springs are arranged;

FIG. 6 is a fragmentary cross-sectional view of a processing machine according to a second embodiment of the present invention, and depicts a part of a processor wheel mounted on the mount and including a polishing pad arranged on a lower surface of the annular base;

FIG. 7 is a fragmentary cross-sectional view of a processing machine according to a third embodiment of the present invention, and depicts a part of a processor wheel mounted on the mount and including a single point cutting tool arranged on the lower surface of the annular base;

FIG. 8 is a cross-sectional view illustrating how a workpiece held on a holding unit is ground by the processing unit of FIG. 2; and

FIG. 9 is a cross-sectional view illustrating how the processor wheel is dismounted from the mount in the processing unit of FIG. 2.

### DETAILED DESCRIPTION OF THE PREFERRED EMBODIMENTS

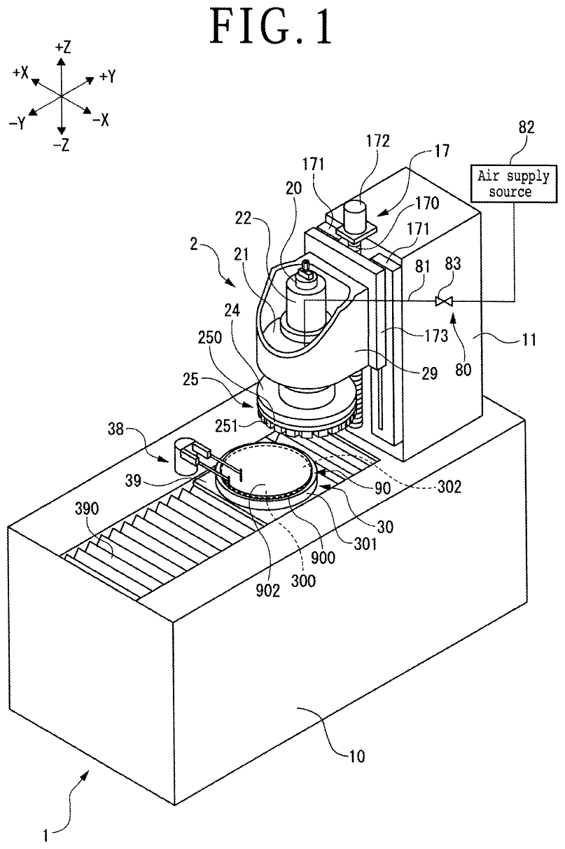

Referring to FIG. 1, a processing machine 1 according to a first embodiment of the present invention is a grinding machine that applies grinding processing to a workpiece 90, which is held under suction on a holding unit 30 such as a chuck table, by a processing unit 2. A front part (on a side of −Y direction) on a machine base 10 of the processing machine 1 is a loading/unloading region where loading/unloading of the workpiece 90 is performed onto/from the holding unit 30, while a rear part (on a side of +Y direction) on the machine base 10 is a processing region where grinding processing of the workpiece 90 held on the holding unit 30 is performed by the processing unit 2.

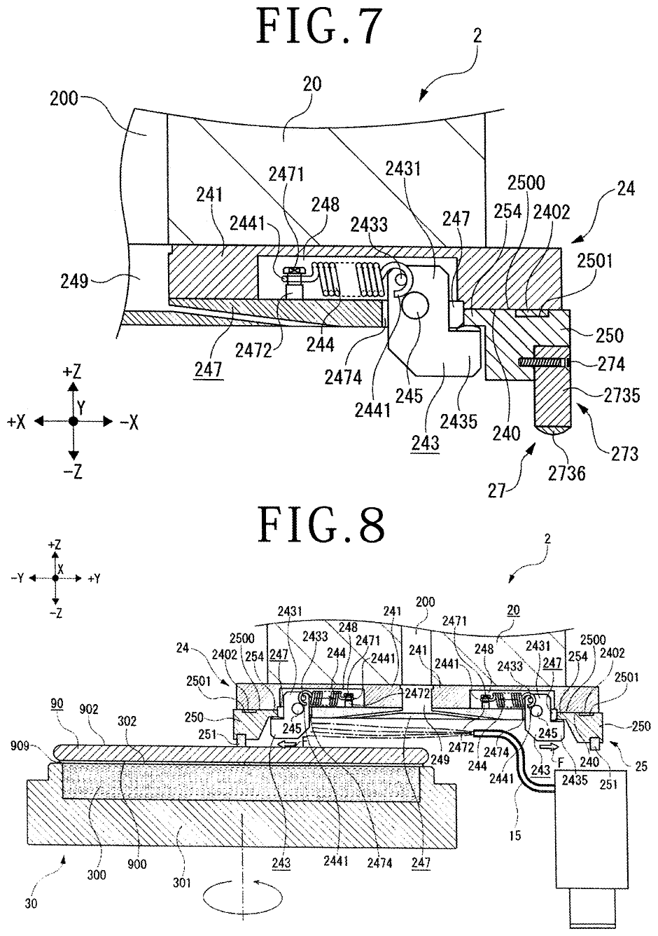

It is to be noted that the processing machine according to the present invention should not be limited to a processing machine in which a processing unit is single axis as in the processing machine 1 but may be a two axis processing machine or the like which includes a coarse processing unit and a finish processing unit, and can position the workpiece 90 at a location below the coarse processing unit or the finish processing unit by a rotating turn table. Further, the processing machine 1 may be a polishing processing machine that applies polishing processing to the workpiece 90 by a polishing pad as will be described subsequently herein as a second embodiment of the present invention with reference to FIG. 6, or a surface planer that planarizes a to-be-processed surface, specifically a back side 902 of the workpiece 90 by a single point cutting tool as will be described subsequently herein as a third embodiment of the present invention with reference to FIG. 7.

The workpiece 90 is, for example, a disc-shaped semiconductor wafer made of a silicon base material or the like, but without being limited to such a material, may be made of gallium arsenide, sapphire, ceramics, resin, gallium nitride, silicon carbide, or the like. A front side 900 of the workpiece 90, which is directed downward in FIG. 1, carries a plurality of devices formed thereon, and is protected with a protective tape 909 (see FIG. 8) bonded thereto. The upwardly directed back side 902 of the workpiece 90 becomes, for example, a to-be-ground surface to which grinding processing is to be applied.

The holding unit 30 which is circular in external shape as seen in a plan view includes a suction portion 300 that is configured, for example, of a porous member or the like and holds the workpiece 90 under suction, and a frame member 301 that supports the suction portion 300. The suction portion 300 of the holding unit 30 is communicated to an undepicted suction source such as an ejector system or a vacuum generator. A suction force produced as a result of a suction by the suction source is transmitted to a holding surface 302 configured of an exposed surface of the suction portion 300 and an upper surface of the frame member 301, whereby the holding unit 30 can hold the workpiece 90 under suction on the holding surface 302.

The holding unit 30 is rotatable about an undepicted rotary shaft, an axial direction of which extends in a direction of Z-axis (vertical direction), as an axis of rotation with the holding unit 30 being surrounded along a periphery thereof by a cover 39, and is reciprocally movable in a direction of Y-axis on the machine base 10 by an undepicted Y-axis moving mechanism, such as an electric slider, arranged underneath the cover 39 and a bellows-shaped cover 390 that is connected to the cover 39 and expands and contacts in the direction of Y-axis.

In the processing region, a column 11 is disposed upright, and on a front wall on the side of −Y direction of the column 11, a lift mechanism 17 is arranged to perform a grinding feed of the processing unit 2 in the direction of Z-axis so that the processing unit 2 moves away from or close to the holding unit 30. The lift mechanism 17 includes a ball screw 170 an axial direction of which extends in the direction of Z-axis, a pair of guide rails 171 arranged parallel to the ball screw 170, a lift motor 172 connected to an upper end of the ball screw 170 to rotate the ball screw 170, and an up/down plate 173 maintained at a rear wall thereof in threaded engagement with the ball screw 170 via nuts and at side portions thereof in sliding contact with the guide rails 171. When the ball screw 170 is rotated in a predetermined direction, for example, clockwise by the lift motor 172, the up/down plate 173 is lowered in the direction of Z-axis in association with the rotation of the ball screw 170 while being guided by the guide rails 171, and the processing unit 2 fixed on the up/down plate 173 is subjected to a grinding feed in the direction of Z-axis.

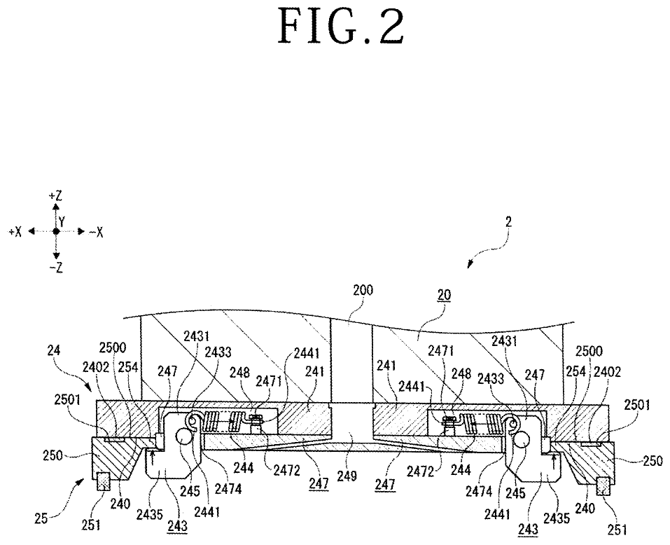

The processing unit 2, which performs grinding processing of the workpiece 90 held on the holding unit 30, includes a spindle 20 having an axial direction extending in the direction of Z-axis, a housing 21 rotatably supporting the spindle 20, a motor 22 that rotationally drives the spindle 20, an annular mount 24 connected to a distal end (lower end) of the spindle 20, a processor wheel 25 detachably mounted on a lower surface, in other words, a flat mounting surface 240 (see FIG. 2) of the mount 24, and a holder 29 supporting the housing 21 and fixed on the up/down plate 173 of the lift mechanism 17.

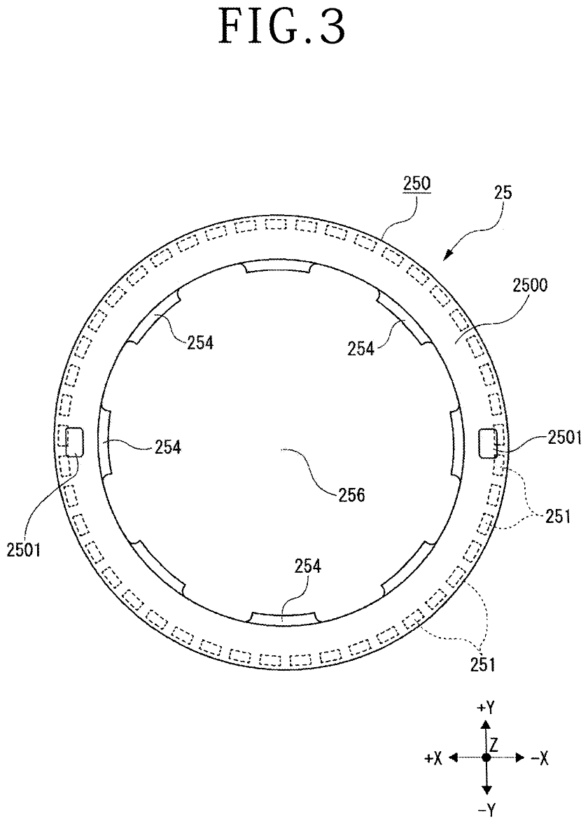

In this embodiment, the processor wheel 25 is a grinding wheel. Described specifically, the processor wheel 25 depicted in FIG. 2 includes an annular base 250 having a ring shape as seen in a plan view, a processor 251 formed of a plurality of grinding stones having a substantially rectangular prism shape and arranged in an annular pattern on a lower surface of the annular base 250, at least two flange portions 254 arranged at equal angular intervals on an inner peripheral surface of the annular base 250 and extending toward a center of the processor wheel 25, and a circular opening 256 (see FIG. 3) formed centrally of the annular base 250. The grinding stones have each been formed, for example, by bonding diamond grits or the like together with a resin bond, a metal bond, or the like. The processor 251 may be a segmented grinding stone formed by arraying chips, which have been obtained by segmenting such grinding stones as described above, in an annular pattern at predetermined intervals therebetween, or a grinding stone that the processor 251 is formed in a single annular ring shape.

As depicted by way of example in FIG. 3, eight flange portions 254 are integrally formed in a substantially trapezoidal shape as seen in a plan view on an inner peripheral surface of the annular base 250 at angular intervals of 45 degrees in a peripheral direction of the processor wheel 25, although the number and shape of the flange portions 254 should not be limited to this example. Each flange portion 254 is disposed opposite to another one in a horizontal plane (in X-Y axis plane) with the center of the processor wheel 25 located between them. Upper surfaces of the flange portions 254 and a flat upper surface 2500 of the annular base 250 are flush with each other.

As depicted by way of example in FIGS. 2 and 3, two first recessed portions 2501 of, for example, a substantially rectangular shape as seen in a plan view are formed at an angular interval of 180 degrees in the upper surface 2500 of the annular base 250 so that the below-described first projected portions 2402 of the mount 24 can be fitted thereinto. The shape and number of the first recessed portions 2501 should not be limited to this example.

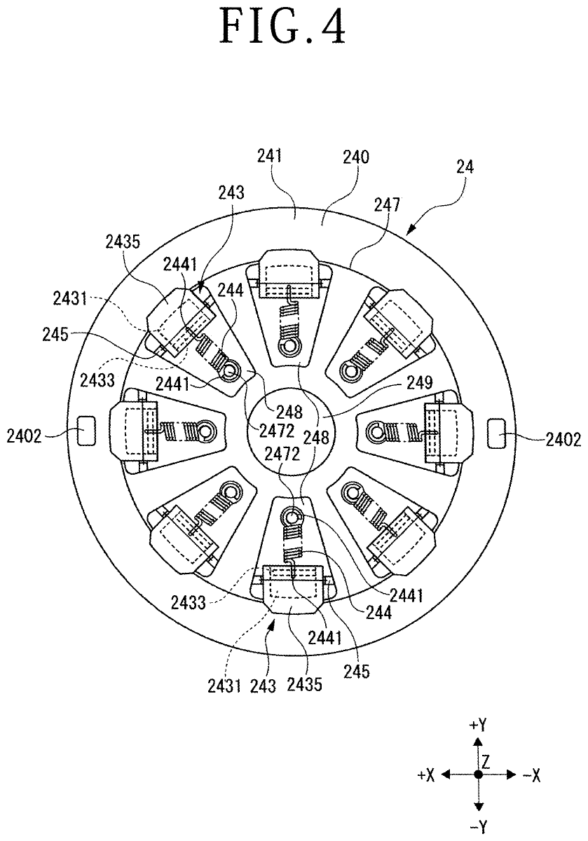

As depicted in FIG. 2, the spindle 20 is connected at the lower end thereof to a flat upper surface of the mount 24 with a center of the mount 24 and that of the spindle 20 matching each other. As depicted in FIGS. 2 and 4, the mount 24 includes clasp portions 243 configured to clasp the flange portions 254, respectively, springs 244, such as tension coil springs, biasing the clasp portions 243, respectively, in an upward direction in the axial direction of the spindle 20 (in the direction of Z-axis), and support portions 245 configured to support the respective clasp portions 243 movably in the axial direction of the spindle 20 (in the direction of Z-axis).

Inside a short cylindrical mount base portion 241 of the mount 24 depicted in FIGS. 2 and 4, eight receiving pockets 248 are disposed at angular intervals of 45 degrees in a peripheral direction of the mount 24, and each receiving pocket 248 is formed, for example, in a substantially trapezoidal shape as seen in a plan view. In each receiving pocket 248, respective ones of the clasp portions 243, springs 244, and support portions 245 are arranged, and the receiving pockets 248 each have a size sufficient to permit movement of the associated clasp portion 243 and expansion and contraction of the associated spring 244.

As depicted in FIG. 2, a round raised portion 247 of a smaller diameter than the mount base portion 241 is formed below the receiving pockets 248 with a predetermined thickness in the direction of Z-axis and extends radially in the direction of X-axis, so that the receiving pockets 248 are closed in bottom regions thereof other than on the side of an outer periphery of the mount base portion 241. The round raised portion 247 substantially matches at a center thereof with a center of the mount base portion 241, and is set at a diameter corresponding to an inner diameter of the processor wheel 25, specifically a diameter of the opening 256 depicted in FIG. 3 with the inwardly protruding dimension of each flange portion 254 taken into account. Therefore, the round raised portion 247 is fitted in the circular opening 256 of the processor wheel 25, whereby the center of the mount 24 and the center of the processor wheel 25 mounted on the mounting surface 240 are allowed to match each other. An outer peripheral surface of the round raised portion 247 is in contact with inner edge surfaces of the flange portions 254.

For allowing the center of the mount 24 and the center of the processor wheel 25 mounted on the mounting surface 240 to match each other, a plurality of positioning pins may be arranged in place of the round raised portion 247 on the lower surface of the mount base portion 241 along an outer periphery of the round raised portion 247 virtually disposed on the lower surface of the mount base portion 241.

As depicted in FIG. 2, substantially cylindrical anchor bolts 2472 are disposed upright on an upper surface of the round raised portion 247 at locations corresponding to the respective receiving pockets 248 to fixedly fasten, for example, by nuts 2471 the associated springs 244 on the side of inner ends thereof located on the side of the center of the mount 24. On an upper outer peripheral surface of each anchor bolt 2472, threads are formed. The anchor bolt 2472 is inserted in a hook 2441 formed on the side of the inner end of the spring 244, and the nut 2471 is then brought into threaded engagement with the threads of the anchor bolt 2472, whereby the spring 244 can be fixed on the side of the inner end thereof in the associated receiving pocket 248. For example, the round raised portion 247 is configured to be detachable from the mount base portion 241, and therefore an operator can perform an adjustment or the like of the mount base portion 241 with the springs 244 and the like exposed from the receiving pockets 248.

The springs 244 are, for example, tension coil springs horizontally extending outward in a radial direction of the mount 24. Each spring 244 has the hook 2441 formed on the side of the inner end thereof, and another hook 2441 formed on the side of an outer end thereof. With the hook 2441 on the side of the outer end of the spring 244 secured on a connecting bar 2433 arranged on the associated clasp portion 243 and horizontally extending in a direction orthogonal to the radial direction of the mount 24 so that the connecting bar 2433 intersects the spring 244 at substantially right angles and also with the hook 2441 on the side of the inner end of the spring 244 secured on the anchor bolt 2472, the anchor bolt 2472 and the connecting bar 2433 are connected to each other via the spring 244. As an alternative, the anchor bolt 2472 and the connecting bar 2433 may be connected to each other using a horizontally stretchable rubber rod in place of the spring 244.

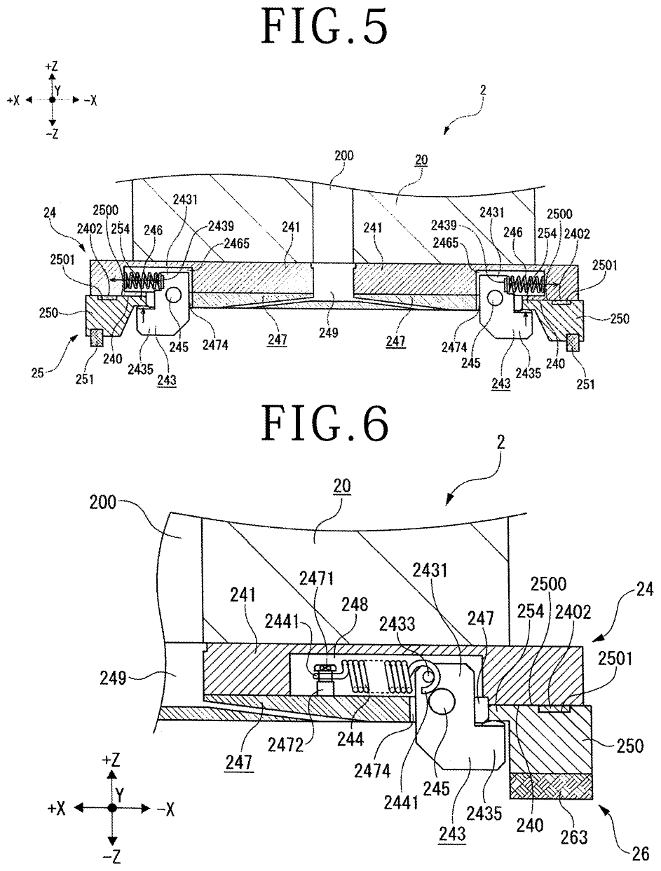

In place of the tension coil springs exemplified above, the springs 244 may also be compression coil springs 246 depicted as a modification in FIG. 5. When the compression coil springs 246 depicted in FIG. 5 are used, the clasp portions 243 are provided at upper base portions 2431 thereof with prop-up plates 2439, respectively, in place of the connecting bars 2433. Further, inside the mount base portion 241, spring receiving pockets 2465 are formed at locations on radially outer sides of the prop-up plates 2439 to accommodate the compression coil springs 246, respectively. As depicted in FIG. 5, with the processor wheel 25 mounted on the mount 24, each compression coil spring 246 accommodated in the associated spring receiving pocket 2465 and extending in the radial direction of the mount base portion 241 connects an inner wall of the spring receiving pocket 2465 and the associated prop-up plate 2439, and acts to widen the distance between the inner wall of the spring receiving pocket 2465 and the prop-up plate 2439. In other words, the compression coil spring 246 acts to move the associated upper base portion 2431 away relative to the inner wall of the spring receiving pocket 2465 toward the center of the mount 24 via the prop-up plate 2439, whereby a force is applied so that the clasp portion 243 turns as a whole about the support portion 245 as a fulcrum. As a result, a contact claw portion 2435 is biased in an upward direction as indicated by an arrow, and therefore the associated flange portion 254 is pressed against the mounting surface 240 of the mount 24 by the contact claw portion 2435.

The clasp portion 243 is not limited to the above-described configuration insofar as the clasp portion 243 is configured to turn about the support portion 245 as the fulcrum, in other words, a pivot so that the contact claw portion 2435 is biased in the upward direction as indicated by the arrow. The compression coil spring 246 may be arranged to extend in a vertical direction (in the direction of Z-axis) rather than a horizontal direction.

Corresponding to the number of the flange portions 254, for example, eight clasp portions 243 are arranged at angular intervals of 45 degrees in the peripheral direction of the mount 24. Each clasp portion 243 is formed, for example, in a substantially L shape as seen in a side view, with a horizontal arm thereof being directed outward in the radial direction, as depicted in FIG. 2, and includes the upper base portion 2431 accommodated in the receiving pocket 248, the contact claw portion 2435 formed integrally with the upper base portion 2431, exposed on a lower outer side of the mount 24 from a through-hole 2474 formed in a region on an outer peripheral side of the round raised portion 247, and maintained in contact with flange portion 254 of the processor wheel 25, and the connecting bar 2433 arranged, for example, on the upper base portion 2431.

Each support portion 245 depicted in FIGS. 2 and 4 is, for example, a pivot fittingly inserted so that the pivot extends through the upper base portion 2431 of the clasp portion 243 from a side surface to an opposite side surface, and is rotatably connected at opposite ends thereof, for example, to the round raised portion 247 via undepicted bearings or the like. In this embodiment, the clasp portion 243 is configured to rotate in association with rotation of the support portion 245. However, the clasp portion 243 alone may be configured to rotate relative to the support portion 245 that is fixed.

Eight through-holes 2474, which are formed in a thickness direction through the round raised portion 247 at angular intervals of 45 degrees in the peripheral direction of the round raised portion 247, are set in a size sufficient to permit turning of the associated clasp portions 243. Each contact claw portion 2435, which is exposed to the lower outer side of the mount 24 from the through-hole 2474 of the clasp portion 243, acts at an upper surface thereof as a supporting surface that comes into contact from below with the flange portion 254 of the processor wheel 25 and supports the flange portion 254. The supporting surface and an outer peripheral edge of the supporting surface are rounded to have an inclination. The rounded configurations of the support surface and the outer peripheral edge of the support surface as described above lead to a reduction in friction or the like at the time of a contact between the contact claw portion 2435 and the flange portion 254.

On the mounting surface 240 of the mount 24 depicted in FIGS. 2 and 4, two first projected portions 2402, for example, in the form of a substantially rectangular prism are formed at angular intervals of 180 degrees in the peripheral direction. The first projected portions 2402 can be fitted into the first recessed portions 2501 formed in the upper surface 2500 of the annular base 250.

As an alternative, second projected portions may be disposed upright on the upper surface 2500 of the annular base 250, and second recessed portions into which the second projected portions can be fitted may be formed in the mounting surface 240 of the mount 24. In this alternative configuration, hexagon socket head cap screws may be inserted into internally threaded holes formed in an upper surface of an existing annular base to be fixed with bolts, and heads of the hexagon socket head cap screws may be used as the second projected portions on the annular base 250.

Inside the spindle 20, a flow channel 200 is disposed extending in the axial direction of the spindle 20 (in the direction of Z-axis) as depicted in FIG. 2. The flow channel 200 communicates to an undepicted grinding water supply source, and serves as a flow path for grinding water. The flow channel 200 further communicates to a mount flow path 249 formed centrally of the mount 24. Inside the mount base portion 241, the mount flow path 249 extends in the direction of Z-axis, and then branches radially as seen in a plan view at predetermined intervals toward an outer periphery of the round raised portion 247, whereby a plurality of branch flow paths is formed. These branch flow paths lead to openings, respectively, on the side of outer ends thereof, for example, in respective regions on the side of an outer periphery of the lower surface of the round raised portion 247. The mount flow path 249 is therefore configured to eject the grinding water from the openings against the processor 251.

The branch flow paths are formed through the mount 24 in respective regions between the individual receiving pockets 248. No situation hence arises that the grinding water ejected from the openings of the branch flow paths may be blocked by the clasp portions 243 and may fail to reach the processor 251.

The processing unit 2 depicted in FIGS. 1 and 2 may preferably include a fixing system 80 to fix the spindle 20 and the mount 24 so that they do not rotate at the time of a replacement or the like of the processor wheel 25. A description will hereinafter be made about a specific example of the fixing system 80 depicted in FIG. 1.

The housing 21 that rotatably supports the spindle 20 includes, for example, an air spindle system to rotatably support the spindle 20 via air bearings. The air bearing system forms an air layer of high-pressure air in a clearance between the housing 21, which is, for example, cylindrical, and the spindle 20, and contactlessly supports the spindle 20 by the pressure of the air layer, whereby the housing 21 is allowed to rotatably support the spindle 20 without friction resistance.

An air supply source 82 including a compressor or the like is communicated to the housing 21 via an air supply pipe 81, and an on/off valve 83 such as a solenoid valve is arranged in the air supply pipe 81. The fixing system 80 controls on/off operation of the on/off valve 83, for example, through control of energization of the on/off valve 83, and at the time of a replacement or the like of the processor wheel 25, closes the on/off valve 83, whereby the supply of air into the housing 21 is stopped to prevent rotation of the spindle 20 even if a force is applied to the spindle 20.

Referring next to FIG. 6, a processing machine according to the second embodiment of the present invention will be described. The processor wheel which the processing unit 2 includes may be, for example, a processor wheel 26 with a processor 263 arranged as the polishing pad on the lower surface of the annular base 250 as depicted in FIG. 6, specifically a polishing wheel 26 in place of the processor wheel 25 as the grinding wheel. The processor 263 can provide the workpiece 90, which is depicted in FIG. 1, with enhanced flexural strength by polishing its back side 902.

The processor wheel 26 is substantially the same as the processor wheel 25 except that the processor 263 is the polishing pad, and therefore the processor 263 alone will be described hereinafter. The processor 263 as the polishing pad is made from a nonwoven fabric such as a felt, formed in an annular shape as seen in a plan view, and has, for example, a larger diameter than the workpiece 90 to be held on the holding unit 30. As an alternative, the processor 263 may be formed by bonding abrasive grits on a nonwoven fabric with an adhesive.

The processor 263 includes, for example, grooves formed in a grid pattern in its lower surface where the processor 263 comes into contact with the workpiece 90. A slurry is supplied to the processor 263, for example, through an inside of the processing unit 2 or from an undepicted slurry nozzle arranged outside the processing unit 2, and is allowed to flow primarily in the grooves so that the slurry progressively spreads over the entire lower surface of the processor 263. As an alternative, the processor 263 may be one for use in dry polishing rather than chemical mechanical planarization (CMP) polishing that uses the slurry.

Referring next to FIG. 7, a processing machine according to a third embodiment of the present invention will be described. The processor wheel which the processing unit 2 includes may be, for example, a processor wheel 27 with a processor 273 arranged as the single point cutting tool on the lower surface of the annular base 250 as depicted in FIG. 7, specifically a single point cutting wheel 27 in place of the processor wheel 25 as the grinding wheel. The processor 273 can provide the workpiece 90 with enhanced flatness by performing turning processing of its back side 902.

The processor wheel 27 is substantially the same as the processor wheel 25 except that the processor 273 is the single point cutting tool, and therefore the processor 273 alone will be described hereinafter. The processor 273 includes a strip-shaped shank 2735 fixed on the bottom surface or a side surface of the annular base 250 by anchor bolts 274 or the like, and a cutting edge 2736 formed in a pointed shape or the like on a lower end of the strip-shaped shank 2735. The cutting edge 2736 may be, for example, a diamond bite or the like, and is in a state that downwardly projects over a predetermined length from the lower surface of the annular base 250.

Referring back to FIG. 1, thickness measuring means 38 that measures the thickness of the workpiece 90, for example, by a contact method is arranged at a location adjacent the processing unit 2 that has been lowered to a grinding position.

A description will hereinafter be made about operation of the processing machine 1 depicted in FIG. 1 when the workpiece 90 held on the holding unit 30 is ground by the processor wheel 25. In the loading/unloading region, the workpiece 90 is first placed on the holding surface 302 of the holding unit 30 with their centers substantially matching each other. Under a suction force produced by the undepicted suction source, the holding unit 30 holds the workpiece 90 under suction on the holding surface 3021.

The holding unit 30 with the workpiece 90 held thereon is next moved in +Y direction from the loading/unloading region to below the processing unit 2 in the processing region. As illustrated in FIG. 8, the holding unit 30 is then positioned relative to the processor wheel 25 so that the center of rotation of the processor wheel 25 is offset by a predetermined distance in the horizontal direction relative to the center of rotation of the workpiece 90 and the trace of rotation of the processor 251 passes through the center of rotation of the workpiece 90. Next, the processing unit 2 is fed at a predetermined grinding feed rate in −Z direction by the lift mechanism 17, and the processor 251 which is rotating at a predetermined rotational speed is brought into contact with the upwardly directed back side 902 of the workpiece 90 so that grinding processing is performed. Concurrently with the rotation of the holding unit 30 at a predetermined rotational speed, the workpiece 90 held on the holding surface 302 is also rotated, whereby the workpiece 90 is polished on the entire back side 902. During the grinding processing, grinding water is supplied to a point of contact between the processor 251 and the workpiece 90 through the flow channel 200 in the spindle 20, the mount flow path 249 and the above-described branch flow paths to cool and rinse the point of contact.

As illustrated in FIG. 8, the processor wheel 25 is positioned with a section thereof protruding from the holding unit 30 in the horizontal direction. A polishing water ejection nozzle 15 may be arranged inside the protruding section of the processor wheel 25, and polishing water ejected from the polishing water ejection nozzle 15 may be supplied directly to the point of contact between processor 251 and the workpiece 90.

While performing thickness measurement of the workpiece 90 by the thickness measuring means 38 depicted in FIG. 1, the workpiece 90 is ground to a desired thickness, and the processor wheel 25 is then raised so that the processor 251 is separated from the workpiece 90 to end the grinding processing.

When a plurality of workpieces 90 is successively polished as described above, the processor 251 is worn out so that the processor wheel 25 requires a replacement. A description will hereinafter be made about the replacement of the processor wheel 25.

A description will first be made about a state in which the processing unit 2 has been assembled ready for grinding the workpiece 90, in other words, a state in which the processor wheel 25 depicted in FIGS. 2 and 8 has been mounted on the mount 24. The round raised portion 247 is fitted in the circular opening 256 (see FIG. 3) of the processor wheel 25 depicted in FIGS. 2 and 8 with the center of the mount 24 and the center of the processor wheel 25 mounted on the mounting surface 240 matching each other. Further, the first projected portions 2402 of the mount 24 are fitted in the first recessed portions 2501 of the annular base 250, respectively, and the flat upper surface 2500 of the annular base 250 is in contact with the flat mounting surface 240 of the mount 24.

Further, each spring 244 pulls the upper base portion 2431 of the associated clasp portion 243 toward the center of the mount 24 via the connecting bar 2433, whereby the contact claw portion 2435 is raised toward the flange portion 254 with the support portion 245, which supports the clasp portion 243, acting as a fulcrum. In other words, the rounded upper surface of the contact claw portion 2435 moves in +Z direction, that is, the axial direction of the spindle 20, and comes into contact with the lower surface of the flange portion 254. In this state, the contact claw portion 2435 of the clasp portion 243 is biased upward in the axial direction of the spindle 20, that is, in the direction of Z-axis. As a result, the flange portion 254 is pressed from below against the mounting surface 240 of the mount 24 by the contact claw portion 2435, and is brought into a state in which the flange portion 254 is clasped by the clasp portion 243 and is fixedly held between the mount 24 and the contact claw portion 2435.

Into the housing 21 of the processing unit 2 depicted in FIG. 1 with the processor wheel 25 mounted on the mount 24 as described above, compressed air is supplied from the air supply source 82 through the on/off valve 83, which is in an open state, and the air supply pipe 81, and the spindle 20 is contactlessly supported for rotation by the housing 21 without occurrence of scoring and the like.

When the spindle 20 is rotated by the motor 22 as described above, the processor wheel 25 is rotated to enable grinding of the workpiece 90 by the processor wheel 25. While the processor wheel 25 is rotating together with the spindle 20, a centrifugal force F is applied to each clasp portion 243 as illustrated in FIG. 8. Here, the upper base portion 2431 is pulled toward the center of the mount 24 by the spring 244. Owing to the centrifugal force F so applied, the force that is pushing the mounting surface 240 of the mount 24 upward from below by the contact claw portion 2435 is further enhanced, whereby the processor wheel 25 is maintained in still closer contact with the mounting surface 240 of the mount 24. Accordingly, the processor 251 is suppressed from wobbling on the workpiece 90, thereby as described above, enabling to avoid leaving adverse effects on the back side 902, that is, the processed surface of the workpiece 90 after the above-described processing and also to provide the back side 902 with enhanced flatness after the griding.

When dismounting the processor wheel 25 from the mount 24 in the state that as described above, the processing unit 2 has been assembled to enable polishing of the workpiece 90, in other words, the processor wheel 25 is mounted on the mount 24, the rotation of the spindle 20 by the motor 22 is first stopped, and the on/off valve 83 of the fixing system 80 depicted in FIG. 1 is then closed to stop the supply of air into the housing 21. The processing machine 1 is therefore brought into a state that neither the spindle 20 nor the mount 24 rotates even if a force is applied by the operator's replacement work.

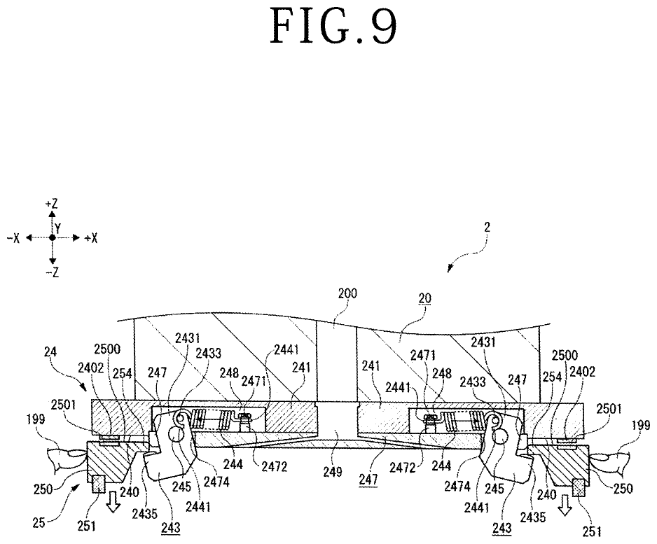

As illustrated in FIG. 9, the operator next applies a force to lower the processor wheel 25 in −Z direction with the processor wheel 25 held at an outer side surface thereof, for example, by both hands 199, whereby each flange portion 254 is moved in −Z direction while pushing the associated contact claw portion 2435 downward. Further, the clasp portion 243 is lowered while using the support portion 245, which supports the clasp portion 243, as a fulcrum, so that the spring 244 fixed on the side of the inner end thereof is caused to expand outward in the horizontal direction and stores a contracting biasing force. The first projected portions 2402 of the mount 24 are then unfitted from the first recessed portions 2501 of the annular base 250, respectively, leading to a state that the processor wheel 25 has been dismounted from the mount 24. Subsequently, each spring 244 contracts again, and the associated clasp portion 243 also returns to a state in which, for example, the upper surface of the contact claw portion 2435 lies parallel to a horizontal plane.

As described above, the processing machine 1 according to each embodiment of the present invention includes the processing unit 2 that has the processor wheel 25, 26, or 27 with the processor 251, 263, or 273 fixed on the lower surface of the annular base 250 and the mount 24 fixed on the distal end of the spindle 20, and processes the workpiece 90 by the processor 251, 263, or 273 with the processor wheel 25, 26, or 27 mounted on the mounting surface 240 of the mount 24, and the holding unit 30 that holds the workpiece 90. The processor wheel 25, 26, or 27 has the plurality of flange portions 254 arranged at equal angular intervals on the inner peripheral surface of the annular base 250 and extending from the inner peripheral surface toward the center of the processor wheel 25, 26, or 27. The mount 24 has the plurality of clasp portions 243 configured to clasp the flange portions 254, respectively, the plurality of springs 244 biasing the clasp portions 243, respectively, in the upward direction in the axial direction of the spindle 20, and the plurality of support portions 245 configured to support the respective clasp portions 243 movably in the axial direction. The mount 24 has the at least one projected portion 2402 or recessed portion formed on or in the mounting surface 240, and the annular base 250 has the at least one recessed portion 2501 or projected portion formed in or on the upper surface 2500 thereof, and the projected portion 2402 or recessed portion formed on or in the mounting surface 240 and the recessed portion 2501 or projected portion formed in or on the upper surface 2500 of the annular base 250 are in detachable fitting engagement with each other, whereby the processor wheel 25, 26, or 27 mounted on the mounting surface 240 is prevented from rotating on the mounting surface 240. Therefore, it is no longer necessary to perform installation or removal of screws when mounting or dismounting the processor wheel 25, 26, or 27 on or from the mount 24. As a consequence, the processor wheel 25, 26, or 27 can be replaced in a short time.

Further, the processing unit 2 includes the fixing system 80, which at the time of replacement or the like of the processor wheel 25, 26, or 27 on the mount 24, for example, fixes the spindle 20 so that the spindle 20 does not rotate. It is hence possible to appropriately perform with ease the matching work between the mount 24 and the processor wheel 25, 26, or 27, specifically the matching work or the like, for example, between the at least one projected portion 2402 and the at least one recessed portion 2501.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A processing machine comprising:
a processing unit that has a processor wheel with a processor fixed on a lower surface of an annular base and a mount fixed on a distal end of a spindle, and processes a workpiece by the processor with the processor wheel mounted on a mounting surface of the mount; and
a holding unit that holds the workpiece,
wherein the processor wheel has a plurality of flange portions arranged at equal angular intervals on an inner peripheral surface of the annular base and extending from the inner peripheral surface toward a center of the processor wheel,
the mount has a plurality of clasp portions configured to clasp the flange portions, respectively, a plurality of springs biasing the clasp portions, respectively, in an upward direction in an axial direction of the spindle, and a plurality of support portions configured to support the respective clasp portions movably in the axial direction, and
the mount has at least one projected portion or recessed portion formed on or in the mounting surface, and the annular base has at least one recessed portion or projected portion formed in or on an upper surface thereof, and the projected portion or recessed portion formed on or in the mounting surface and the recessed portion or projected portion formed in or on the upper surface of the annular base are in detachable fitting engagement with each other, whereby the processor wheel mounted on the mounting surface is prevented from rotating on the mounting surface.

2. The processing machine according to claim 1,
wherein the processing unit includes a fixing system to fix the spindle so that the spindle does not rotate.

3. The processing machine according to claim 1,
wherein the processor is a grinding wheel, and the processor wheel has a plurality of grinding stones arranged in an annular pattern on a lower surface of the annular base.

4. The processing machine according to claim 1,
wherein the processor is a polishing pad, and the processor wheel has the polishing pad arranged on a lower surface of the annular base.

5. The processing machine according to claim 1,
wherein the processor is a single point cutting tool, and the processor wheel has the single point cutting tool arranged on a lower surface of the annular base.
